(19) United States
(12) Patent Application Publication
(10) Pub. No.: US 2026/0179391 A1
(43) Pub. Date: Jun. 25, 2026

(54) CONTROL DEVICE OF VEHICLE, CONTROL METHOD OF VEHICLE, AND COMPUTER PROGRAM

(71) Applicant: TOYOTA JIDOSHA KABUSHIKI KAISHA, Aichi-ken (JP)

(72) Inventor: Junji MORIGUCHI, Toyota-shi (JP)

(21) Appl. No.: 19/422,497

(22) Filed: Dec. 17, 2025

(30) Foreign Application Priority Data
Dec. 25, 2024 (JP) 2024-229164

(51) Int. Cl. G06V 20/56; B60Q 1/24; G06V 10/26; G06V 10/75

(52) U.S. Cl. CPC G06V 20/588; B60Q 1/24; G06V 10/267; G06V 10/751; G06V 10/759; B60Q 2400/50

(57) ABSTRACT

A control device controls a vehicle including a capturing device, and a road surface drawing device that projects a drawing pattern having a predetermined shape onto a road surface. The drawing pattern in response to a road surface drawing request is projected onto a road surface around the vehicle by the road surface drawing device. A ground object in a surrounding image of the vehicle captured by the capturing device is recognized based on the surrounding image. A recognition result of the drawing pattern is discarded when it is determined that a recognized object in the surrounding image is the drawing pattern.

### FIELD

The present invention relates to a control device of a vehicle, a control method of the vehicle, and a computer program.

### BACKGROUND

PTL 1 discloses, as a conventional vehicle system, a system configured to project a predetermined drawing pattern (road surface drawing) onto a road surface by a road surface drawing means, and thus clarify presence of an own vehicle and a traveling path of the own vehicle for a third person such as a pedestrian present in a traveling direction and a driver of a following vehicle, and attract attention.

### CITATION LIST

### Patent Literature

[PTL 1] Japanese Unexamined Patent Publication (Kokai) No. 2022-108190

### SUMMARY

### Technical Problem

However, the conventional vehicle system described above is configured to limit a projection range of the drawing pattern by the road surface drawing means to a narrow region near the own vehicle by making the projection range narrower than usual when a white line detection means detects a white line in order to avoid false detection in which the white line detection means detects the drawing pattern by the road surface drawing means as the white line. Thus, there is a risk that an effect of attracting attention to a third person by the drawing pattern may be impaired.

The present invention has been made in view of such problems, and has an objective to suppress impairment of an effect of attracting attention by a drawing pattern while suppressing use of a false recognition result in which the drawing pattern is recognized as a ground object such as a road sign by mistake.

### Solution to Problem

In order to solve the problems described above, a vehicle according to a certain aspect of the present invention includes a capturing device, and a road surface drawing device that projects a drawing pattern having a predetermined shape onto a road surface, and a control device of a vehicle that controls this vehicle is configured in such a way that the drawing pattern in response to a road surface drawing request is projected onto a road surface around the vehicle by the road surface drawing device, a ground object in a surrounding image of the vehicle captured by the capturing device is recognized based on the surrounding image, and a recognition result of the drawing pattern is discarded when it is determined that a recognized object in the surrounding image is the drawing pattern.

Further, a control method of a vehicle according to a certain aspect of the present invention is a control method of a vehicle including a capturing device, and a road surface drawing device that projects a drawing pattern having a predetermined shape onto a road surface, and includes: projecting the drawing pattern in response to a road surface drawing request onto a road surface around the vehicle by the road surface drawing device; recognizing a ground object in a surrounding image of the vehicle captured by the capturing device, based on the surrounding image; and discarding a recognition result of the drawing pattern when it is determined that a recognized object in the surrounding image is the drawing pattern.

Further, a computer program according to a certain aspect of the present invention causes a computer to execute processing of: projecting, by a road surface drawing device that projects a drawing pattern having a predetermined shape onto a road surface, the drawing pattern in response to a road surface drawing request onto a road surface around a vehicle; recognizing a ground object in a surrounding image of the vehicle captured by a capturing device, based on the surrounding image; and discarding a recognition result of the drawing pattern when it is determined that a recognized object in the surrounding image is the drawing pattern.

### Advantageous Effects of Invention

According to the aspects of the present invention, impairment of an effect of attracting attention by a drawing pattern can be suppressed while use of a false recognition result in which the drawing pattern is recognized as a ground object such as a road sign by mistake can be suppressed.

### BRIEF DESCRIPTION OF DRAWINGS

FIG. 1 is a schematic configuration diagram of a vehicle according to one embodiment of the present invention.

FIG. 2 is a diagram illustrating one example of a surrounding image captured when a drawing pattern for a right turn is projected onto a road surface in front on the right of the vehicle.

FIG. 3 is a diagram illustrating one example of a surrounding image captured when a drawing pattern for a right turn is projected onto a road surface in front on the right of the vehicle.

FIG. 4 is a flowchart illustrating details of registration processing of a drawing pattern according to one embodiment of the present invention.

FIG. 5 is a flowchart illustrating discarding processing of a recognition result of a drawing pattern according to one embodiment of the present invention.

### DESCRIPTION OF EMBODIMENTS

Hereinafter, embodiments of the present invention will be described in detail with reference to drawings. Note that, in the following description, the same reference sign is provided to a similar component.

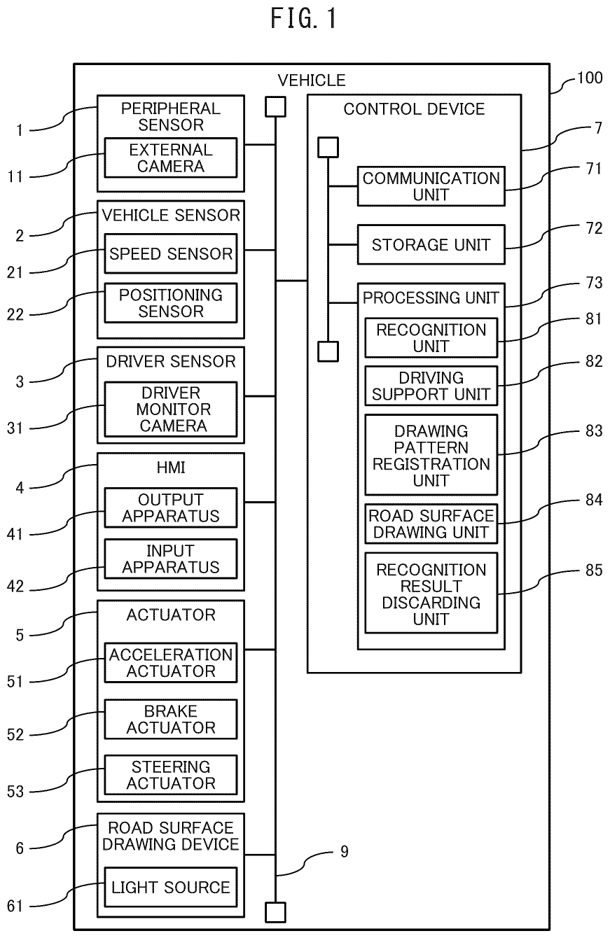

FIG. 1 is a schematic configuration diagram of a vehicle 100 according to one embodiment of the present invention.

The vehicle 100 includes a peripheral sensor 1, a vehicle sensor 2, a driver sensor 3, a human machine interface (HMI) 4, an actuator 5, a road surface drawing device 6, and a control device 7. The peripheral sensor 1, the vehicle sensor 2, the driver sensor 3, the HMI 4, the actuator 5, the road surface drawing device 6, and the control device 7 are each communicably connected via an in-vehicle network 9 conforming to a standard such as a controller area network.

The peripheral sensor 1 is a sensor for generating peripheral data representing a peripheral situation of the vehicle 100. The vehicle 100 according to the present embodiment includes, as the peripheral sensor 1, one or a plurality of external cameras 11 for capturing surroundings of the vehicle 100. The external camera 11 captures the surroundings of the vehicle 100 at a predetermined frame rate (for example, 10 [Hz] to 40 [Hz]), and generates a surrounding image in which the surroundings of the vehicle 100 are captured. Every time the external camera 11 generates a surrounding image, the external camera 11 transmits the generated surrounding image as peripheral data to the control device 7.

Note that, in addition to the external camera 11, a distance measuring sensor that measures a distance to a target and a ground object present around the vehicle 100 may be included as the peripheral sensor 1. Examples of the distance measuring sensor include, for example, a light detection and ranging (LiDAR) that applies radar light and measures a distance, based on the reflected light, a millimeter wave radar sensor that applies a radio wave and measures a distance, based on the reflected wave, and the like.

The vehicle sensor 2 is a sensor for acquiring vehicle data representing a state of the vehicle 100. The vehicle 100 according to the present embodiment includes, as the vehicle sensor 2, a speed sensor 21 that acquires speed data indicating a traveling speed of the vehicle 100, a positioning sensor 22 that acquires current position data indicating a current position of the vehicle 100 such as latitude and longitude, and the like. However, the vehicle sensor 2 is not limited to these sensors. Each piece of data acquired by each of the sensors 21 and 22 is transmitted as the vehicle data to the control device 7.

The driver sensor 3 is a sensor for generating driver data representing a state of a driver. The vehicle 100 according to the present embodiment includes, as the driver sensor 3, a driver monitor camera 31 for capturing an appearance of the driver including a face of the driver. The driver monitor camera 31 captures an appearance of the driver at a predetermined frame rate (for example, 10 [Hz] to 40 [Hz]), and generates an appearance image in which the appearance of the driver is captured. Every time the driver monitor camera 31 generates an appearance image of the driver, the driver monitor camera 31 transmits the generated appearance image as the driver data to the control device 7.

The HMI 4 is a user interface for exchanging information between the vehicle 100 and a passenger of the vehicle 100. The HMI 4 includes an output apparatus 41 for providing a notification to a vehicle passenger through a sense of body (for example, the sense of sight, the sense of hearing, the sense of touch, and the like) of the vehicle passenger, and an input apparatus 42 for performing an input operation and a response operation by the vehicle passenger. The output apparatus 41 is, for example, displays (for example, a meter display, a center display, a head-up display, and the like), a speaker, and the like. The input apparatus 42 is, for example, a touch panel, a microphone, and the like.

The HMI 4 notifies, via the output apparatus 41, the vehicle passenger of information according to an output signal received from the control device 7, and also transmits data input by the vehicle passenger via the input apparatus 42 to the control device 7.

The HMI 4 may be mounted on the vehicle 100 in advance, or may be a terminal such as a smartphone possessed by the vehicle passenger (the driver and a fellow passenger). In the latter case, for example, information may be exchanged by performing communication by short-range wireless communication between the vehicle 100 and the terminal of the vehicle passenger, or communication may be performed between the terminal of the vehicle passenger and an external server (not illustrated) and information may be indirectly exchanged via the server.

The actuator 5 is an apparatus used for traveling control of the vehicle 100. The vehicle 100 according to the present embodiment includes, as the actuator 5, an acceleration actuator 51 (for example, at least one of an engine and a motor) that performs acceleration control of the vehicle 100, a brake actuator 52 (for example, a hydraulic actuator) that performs brake control of the vehicle 100, and a steering actuator 53 (for example, a steering motor) that performs steering control of the vehicle 100.

The road surface drawing device 6 includes a light source 61 such as, for example, an LED, and projects a pattern of a predetermined shape (hereinafter referred to as a “drawing pattern”) indicating behavior (for example, a right/left turn, reversing, open/close of a door, and the like) of the vehicle 100 onto a road surface around the vehicle 100. In this way, presence of the vehicle 100 and behavior of the vehicle 100 can be visually notified to a road user around the vehicle 100, and attention of the road user can be attracted.

The control device 7 is an electronic control unit (ECU) including a communication unit 71, a storage unit 72, and a processing unit 73.

The communication unit 71 includes an interface circuit for connecting the control device 7 to the in-vehicle network 9. The communication unit 71 supplies various types of data received from the outside to the processing unit 73. Further, the communication unit 71 outputs, to the outside, various signals output from the processing unit 73.

The storage unit 72 includes a storage medium such as a hard disk drive (HDD), a solid disk drive (SSD), a semiconductor memory and the like, and stores various computer programs, data, and the like used for processing in the processing unit 73.

The processing unit 73 includes one or a plurality of central processing units (CPUs) and peripheral circuits thereof, and executes various computer programs stored in the storage unit 72. The processing unit 73 is, for example, a processor. The processing unit 73 may further include another arithmetic circuit such as a logical arithmetic unit, a numerical arithmetic unit, or a graphic processing unit. The processing unit 73 executes processing according to a computer program, and thus functions as a recognition unit 81, a driving support unit 82, a drawing pattern registration unit 83, a road surface drawing unit 84, and a recognition result discarding unit 85, and performs a motion as a functional unit (module) that achieves a predetermined function. In the following description, when processing is described with each of the functional units 81 to 85 as a subject, execution of a program that achieves each of the functional units 81 to 85 by the processing unit 73 is indicated.

Contents of specific processing executed in the control device 7 will be described below. In other words, contents of each of the functional units 81 to 85 achieved by executing processing according to a computer program by the processing unit 73 will be described.

The recognition unit 81 recognizes a target and a ground object around the vehicle 100. For example, by successively inputting a surrounding image received from the external camera 11 into an identifier, the recognition unit 81 recognizes, in the surrounding image, a target (e.g. moving target) such as another vehicle, a bicycle, and a pedestrian, and a ground object such as a curbstone, a fence, or another structure (hereinafter referred to as a “division object”) similar to this, and a road sign (for example, a division line that defines a traveling lane, and the like). The identifier can be, for example, a convolutional neural network (CNN) including a plurality of convolutional layers connected in series from an input side toward an output side. Further, for example, the recognition unit 81 computes a distance from the vehicle 100 to a target and a ground object by using a standard size of the target and the ground object stored in the storage unit 72 for each kind of targets and ground objects and a size of the target and the ground object recognized in the surrounding image, and computes a position of the target and the ground object. Note that a method for recognizing a target and a ground object is not limited to such a method, and a target and a ground object may be recognized by various known techniques.

The driving support unit 82 controls the actuator 5, based on the target and the ground object recognized by the recognition unit 81, and executes driving support accompanied by traveling control of the vehicle 100. In the present embodiment, the driving support unit 82 can execute driving support accompanied by traveling control of the vehicle 100 at a driving control level of level 3 by a definition of Society of Automotive Engineers (SAE), i.e., at a driving control level that does not require an operation of each of the actuators 51 to 53 by the driver and monitoring of surroundings. Further, the driving support unit 82 can execute driving support accompanied by traveling control of the vehicle 100 at a driving control level at which the driver gets involved in driving of the vehicle 100, for example, at a driving control level of level 1 or level 2 by a definition of SAE.

The drawing pattern registration unit 83 projects a drawing pattern onto a road surface by the road surface drawing device 6 at a predetermined timing during a vehicle stop such as, for example, a time of vehicle shipment, also generates a surrounding image in which the drawing pattern is captured, and extracts the drawing pattern from the generated surrounding image, and thus stores, in the storage unit 72, the drawing pattern projected onto the road surface by the road surface drawing device 6 of the own vehicle, and registers the drawing pattern projected onto the road surface by the road surface drawing device 6 of the own vehicle.

The road surface drawing unit 84 projects, by the road surface drawing device 6, a drawing pattern in response to a road surface drawing request onto a road surface around the vehicle 100. For example, in response to a turn signal switch (direction indicator) being turned ON, the road surface drawing unit 84 projects a drawing pattern for a right turn onto a road surface in front on the right of the vehicle 100 in a case of right indication, and projects a drawing pattern for a left turn onto a road surface in front on the left of the vehicle 100 in a case of left indication. Further, the road surface drawing unit 84 projects a drawing pattern for reversing onto the rear of the vehicle 100 in response to a shift lever being placed in a reversing range. Further, the road surface drawing unit 84 projects a drawing pattern for door open/close onto a side of the vehicle 100 on a door side touched with a hand of the vehicle passenger in response to a door lever in a room being touched with the hand. A method for detecting whether the door lever in the room is touched with the hand of the vehicle passenger is not particularly limited, but, for example, it can be detected by an infrared sensor built in the door lever.

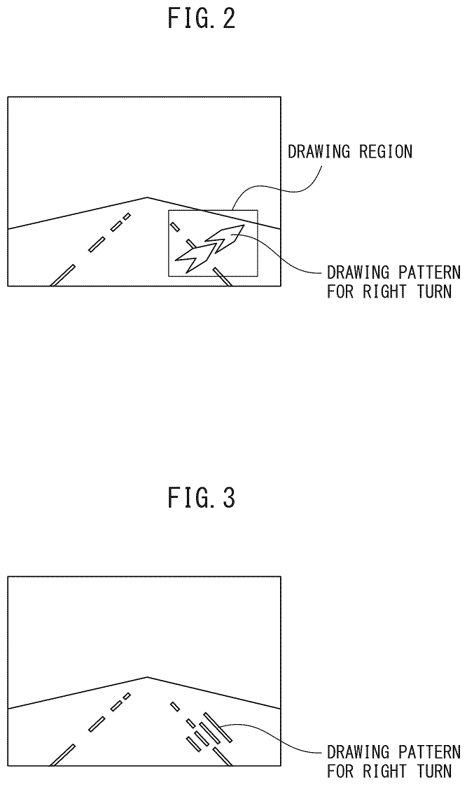

FIG. 2 is a diagram illustrating one example of a surrounding image captured by the external camera 11 when a drawing pattern for a right turn, i.e., a drawing pattern indicating that the driver of the vehicle 100 has an intention to make a right turn is projected onto a road surface in front on the right of the vehicle 100.

The drawing pattern is a relatively simple geometric shape, and, in the present embodiment, as illustrated in FIG. 2, the drawing pattern is a geometric shape simulating an arrow indicating an intended traveling direction of the vehicle 100 or an open direction of a door. As a matter of course, a shape of the drawing pattern is not limited to the shape simulating such an arrow, and can be, for example, various shapes such as a striped pattern constituted from a plurality of lines (four in the example illustrated in FIG. 3) as illustrated in FIG. 3.

When viewed from the vehicle 100, a position in which each drawing pattern is projected is always fixed. In other words, in a case of a drawing pattern for a right turn, as illustrated in FIGS. 2 and 3, the drawing pattern is projected in a predetermined road surface position in front on the right when viewed from the vehicle 100. Then, although not illustrated, in a case of a drawing pattern for a left turn, the drawing pattern is projected in a predetermined road surface position in front to the left when viewed from the vehicle 100, in a case of a drawing pattern for reversing, the drawing pattern is projected in a predetermined road surface position in rear when viewed from the vehicle 100, and, in a case of a drawing pattern for door open/close, the drawing pattern is projected in a predetermined road surface position on a right side or a left side when viewed from the vehicle 100. Therefore, a position of each drawing pattern in a surrounding image captured by the external camera 11 is also always fixed, and each drawing pattern is captured in a predetermined drawing region in the surrounding image for each drawing pattern. In a case of the drawing pattern for the right turn, as illustrated in FIG. 2, a part of a lower right region in the surrounding image in which the front of the vehicle 100 is captured is a drawing region.

Herein, when a drawing pattern is projected onto a road surface around the vehicle 100, there is a risk that the recognition unit 81 may recognize the drawing pattern as a road sign such as a division line by mistake. As a result, there is a risk that driving support accompanied by traveling control of the vehicle 100 may be performed based on a recognition result of recognizing the drawing pattern as the road sign by mistake, and there is a risk that driving support by the driving support unit 82 may be adversely affected. In contrast, for example, as in a conventional technique, when a region where a drawing pattern is projected is limited to a narrow region near a vehicle that cannot be captured by the external camera 11 in order to prevent the recognition unit 81 from recognizing the drawing pattern as a road sign such as a division line by mistake, an effect of road surface drawing of attracting attention of a road user is impaired.

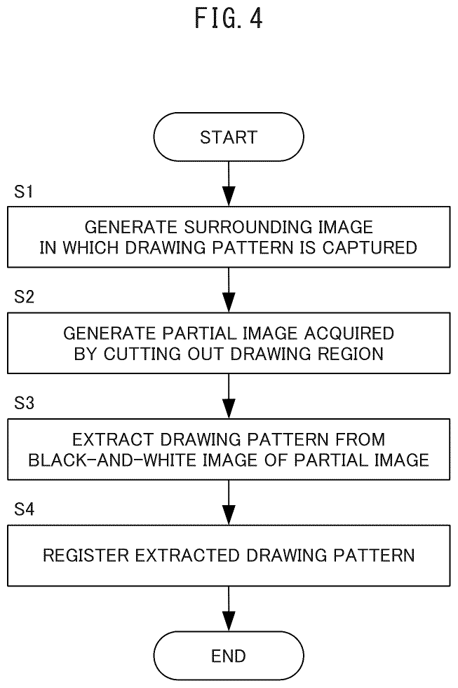

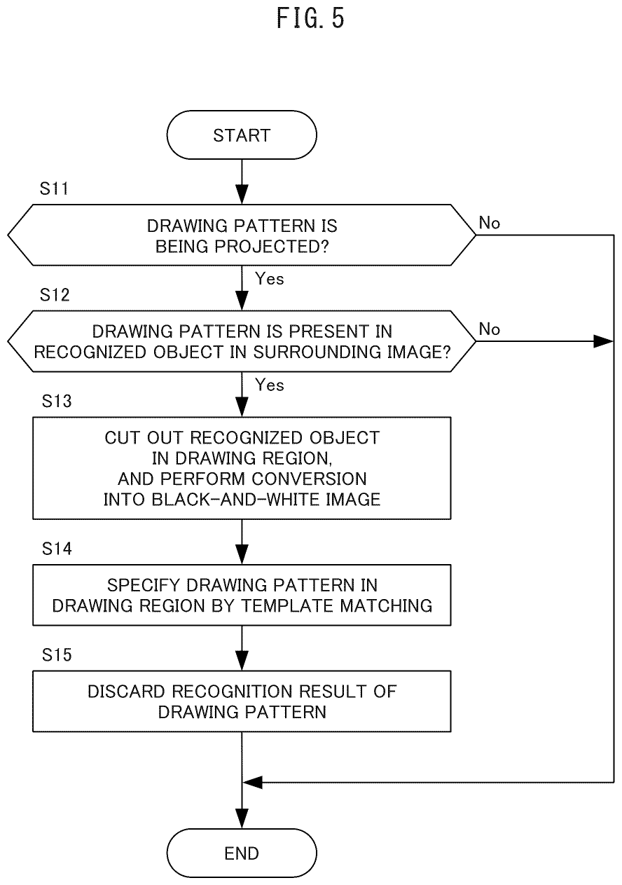

Thus, in the present embodiment, when a drawing pattern is projected, the recognition result discarding unit 85 executes processing of discarding a recognition result of a recognized object determined as the drawing pattern in a surrounding image. In this way, execution of driving support based on a drawing pattern in a surrounding image by the driving support unit 82 can be suppressed. Hereinafter, details of storage processing of a drawing pattern will be described with reference to FIG. 4, and details of the recognition result discarding unit 85 will be then described with reference to FIG. 5.

FIG. 4 is a flowchart illustrating details of registration processing of a drawing pattern executed by the drawing pattern registration unit 83 and thus the control device 7. The control device 7 performs the present routine at a predetermined timing during a vehicle stop such as, for example, a time of vehicle shipment, and stores, in the storage unit 72, a drawing pattern projected onto a road surface by the road surface drawing device 6 of the own vehicle.

In step S1, the control device 7 captures surroundings of the vehicle 100 by the external camera 11 in a state where a drawing pattern is projected onto a road surface by the road surface drawing device 6, and the control device 7 generates a surrounding image in which the drawing pattern is captured.

In step S2, the control device 7 generates a partial image acquired by cutting out a drawing region where the drawing pattern is captured in the surrounding image. As described above, a position in which a drawing pattern is projected is always fixed for each drawing pattern when viewed from the vehicle 100, and thus a position of each drawing pattern in a surrounding image captured by the external camera 11 is also always fixed. Therefore, a predetermined region being predefined in the surrounding image for each drawing pattern can be set as a drawing region.

In step S3, the control device 7 converts the partial image acquired by cutting out the drawing region into a black-and-white image, extracts a line having a geometric characteristic in the black-and-white image, and thus extracts the drawing pattern projected onto the road surface by the road surface drawing device 6 of the own vehicle.

In step S4, the control device 7 stores the extracted drawing pattern as a template image of the drawing pattern in the storage unit 72.

Note that a method for registering a template image is not limited to a registration method by executing registration processing of a drawing pattern for each vehicle in such a manner, and a template image of each drawing pattern may be stored in the storage unit 72 from the beginning.

FIG. 5 is a flowchart illustrating discarding processing of a recognition result of a drawing pattern according to the present embodiment, which is executed by the recognition result discarding unit 85 and thus the control device 7. The control device 7 repeatedly performs the present routine by a predetermined arithmetic cycle.

In step S11, the control device 7 determines whether projection of a drawing pattern by the road surface drawing device 6 is performed. Whether projection of the drawing pattern is performed can be determined by, for example, presence or absence of a road surface drawing request. When projection of the drawing pattern by the road surface drawing device 6 is performed, the control device 7 proceeds to processing in step S12. On the other hand, when projection of the drawing pattern by the road surface drawing device 6 is not performed, the control device 7 ends the processing this time.

In step S12, based on a plurality of surrounding images (for example, a newest image and images before one to several frames, and the like) having continuity in terms of time and being captured by the external camera 11 when the vehicle 100 is moving, the control device 7 determines whether the drawing pattern is present in a recognized object in the surrounding images. As described above, since each drawing pattern is projected in a road surface position being always fixed when viewed from the vehicle 100, each drawing pattern is always captured in the same position in a surrounding image captured by the external camera 11. Therefore, when a recognized object in a drawing region is not moved from the drawing region regardless of a lapse of time (movement of the vehicle) by comparing the plurality of surrounding images having continuity in terms of time, it can be judged that the recognized object is the drawing pattern captured in the surrounding image.

Thus, in the present embodiment, the control device 7 is configured to determine whether a recognized object is a drawing pattern, based on a movement amount of the recognized object in a drawing region of a plurality of surrounding images having continuity in terms of time. Specifically, the control device 7 is configured to determine that a recognized object is a drawing pattern when a movement amount of the recognized object is equal to or less than a predetermined amount, and determine that the drawing pattern is present in a recognized object in surrounding images. On the other hand, the control device 7 is configured to determine that a recognized object is not a drawing pattern when a movement amount of the recognized object is greater than a predetermined amount, and determine that the drawing pattern is not present in a recognized object in surrounding images. When the drawing pattern is present in the recognized object in the surrounding images, the control device 7 proceeds to processing in step S13. On the other hand, when the drawing pattern is not present in the recognized object in the surrounding images, the control device 7 ends the processing this time.

In step S13, the control device 7 cuts out the recognized object in a drawing region, and performs conversion into a black-and-white image.

In step S14, the control device 7 specifies the drawing pattern in the drawing region by performing template matching on the black-and-white image acquired by cutting out the recognized object in the drawing region by using a template image of the drawing pattern being currently projected, which is registered in the storage unit 72 by the drawing pattern registration unit 83.

Note that a method for specifying a drawing pattern in a drawing region is not limited to template matching (pattern matching) by such a black-and-white image (binary image), and a drawing pattern may be specified by various known techniques for, for example, specifying a drawing pattern by using a learned machine learning model (for example, a convolutional neural network (CNN)) being learned in advance in such a way as to specify the drawing pattern, and the like.

In step S15, the control device 7 discards a recognition result of the drawing pattern in the drawing region of the surrounding image. In this way, the recognition result of the drawing pattern is in a discarded state when the driving support unit 82 executes driving support, based on a target and a ground object recognized by the recognition unit 81, and thus execution of driving support while the drawing pattern is recognized as a road sign by mistake can be suppressed. Further, unlike the conventional technique, a region where a drawing pattern is projected is not limited to a narrow region near a vehicle that cannot be captured by the external camera 11, and thus attention of a road user to presence of an own vehicle and behavior of the own vehicle can be attracted without impairing the effect of road surface drawing of attracting attention of the road user.

The vehicle 100 according to the present embodiment described above includes the external camera 11 (capturing device), and the road surface drawing device 6 that projects a drawing pattern having a predetermined shape onto a road surface. The control device 7 of the vehicle 100 is configured in such a way that the drawing pattern in response to a road surface drawing request is projected onto a road surface around the vehicle 100 by the road surface drawing device 6, a ground object in a surrounding image of the vehicle 100 captured by the external camera 11 is recognized based on the surrounding image, and a recognition result of the drawing pattern is discarded when it is determined that a recognized object in the surrounding image is the drawing pattern. Specifically, the control device 7 is configured in such a way that, when it is determined that the recognized object in a drawing region is the drawing pattern, the drawing pattern in the drawing region is specified by comparing an image acquired by cutting out the recognized object in the drawing region with a template image registered as a shape of the drawing pattern, and thus a recognition result of the specified drawing pattern is discarded.

In this way, according to the present embodiment, a recognition result of a drawing pattern can be discarded, and thus use of a false recognition result in which the drawing pattern is recognized as a ground object such as a road sign can be suppressed. Further, there is no regulation in such a way that a projection range of a drawing pattern is narrowed, and the like, and thus impairment of the effect of attracting attention by a drawing pattern can be suppressed.

Further, in the present embodiment, the external camera 11 (capturing device) and the road surface drawing device 6 are disposed in the vehicle 100 in such a way that the drawing pattern is captured in a predetermined drawing region being a region having a predetermined range in the surrounding image, and the control device 7 is further configured to determine whether the recognized object is the drawing pattern, based on a movement amount of the recognized object in the drawing region of a plurality of the surrounding images having continuity in terms of time. Specifically, the control device 7 is configured to determine that the recognized object is the drawing pattern when the movement amount of the recognized object is equal to or less than a predetermined amount.

In this way, whether a recognized object is a drawing pattern can be accurately determined by using a fact that a position of each drawing pattern in a surrounding image captured by the external camera 11 is always fixed.

Although the embodiments of the present invention have been described above, the embodiments described above only indicate a part of the application example of the present invention, and do not intend to limit the technical scope of the present invention to the specific configuration of the embodiments described above.

For example, in the embodiments described above, a computer program executed in the control device 7 may be provided in form of being recorded in a computer-readable portable recording medium, such as a semiconductor memory, a magnetic recording medium, or an optical recording medium, and may be provided as a computer program product.

1. A control device of a vehicle that controls a vehicle, the vehicle including:
a capturing device; and
a road surface drawing device that projects a drawing pattern having a predetermined shape onto a road surface, the control device of a vehicle,
the control device including a processor configured to:
project the drawing pattern in response to a road surface drawing request onto a road surface around the vehicle by the road surface drawing device;
recognize a ground object in a surrounding image of the vehicle captured by the capturing device based on the surrounding image; and
discard a recognition result of the drawing pattern when it is determined that a recognized object in the surrounding image is the drawing pattern.

2. The control device of a vehicle according to claim 1, wherein
the capturing device and the road surface drawing device are disposed in the vehicle in such a way that the drawing pattern is captured in a predetermined drawing region being a region having a predetermined range in the surrounding image, and wherein the processor is configured to determine whether the recognized object is the drawing pattern based on a movement amount of the recognized object in the drawing region of a plurality of the surrounding images having continuity in terms of time.

3. The control device of a vehicle according to claim 2, wherein the processor is configured to determine that the recognized object is the drawing pattern when the movement amount is equal to or less than a predetermined amount.

4. The control device of a vehicle according to claim 2, wherein the processor is configured to specify the drawing pattern in the drawing region by comparing an image acquired by cutting out the recognized object in the drawing region with a template image registered as a shape of the drawing pattern and to discard a recognition result of the specified drawing pattern, when it is determined that the recognized object in the drawing region is the drawing pattern.

5. The control device of a vehicle according to claim 1, wherein the processor is configured to execute driving support accompanied by traveling control of the vehicle based on a recognition result of the ground object in the surrounding image.

6. A control method of a vehicle, the vehicle including:
a capturing device, and
a road surface drawing device that projects a drawing pattern having a predetermined shape onto a road surface, the control method of a vehicle, the control method comprising:
projecting the drawing pattern in response to a road surface drawing request onto a road surface around the vehicle by the road surface drawing device;
recognizing a ground object in a surrounding image of the vehicle captured by the capturing device, based on the surrounding image; and
discarding a recognition result of the drawing pattern when it is determined that a recognized object in the surrounding image is the drawing pattern.

7. A computer-readable recording medium recording a computer program causing a computer to execute processing of:
projecting, by a road surface drawing device that projects a drawing pattern having a predetermined shape onto a road surface, the drawing pattern in response to a road surface drawing request onto a road surface around a vehicle;
recognizing a ground object in a surrounding image of the vehicle captured by a capturing device, based on the surrounding image; and
discarding a recognition result of the drawing pattern when it is determined that a recognized object in the surrounding image is the drawing pattern.
